(19) United States
(12) Patent Application Publication
(10) Pub. No.: US 2026/0178216 A1
(43) Pub. Date: Jun. 25, 2026

(54) STORAGE SYSTEM, NODE CONTROL METHOD, AND PROGRAM

(71) Applicant: Hitachi Vantara, Ltd., Kanagawa-ken (JP)

(72) Inventors: Jun NAKAJIMA, Tokyo (JP); Shinichi HAYASHI, Tokyo (JP); Kaori NAKANO, Tokyo (JP)

(21) Appl. No.: 19/302,904

(22) Filed: Aug. 18, 2025

(30) Foreign Application Priority Data
Dec. 19, 2024 (JP) 2024-224136

(51) Int. Cl. G06F 3/06

(52) U.S. Cl. CPC G06F 3/0655; G06F 3/0604; G06F 3/0679

(57) ABSTRACT

A secondary storage system connected to a primary storage system including a plurality of primary logical volumes in which data is stored, the secondary storage system including: a plurality of storage nodes, each storage node including at least one secondary logical volume; and an arrangement control unit configured to, when there are a plurality of pairs of the primary logical volumes and the secondary logical volumes belonging to the same consistency group, distribute and arrange the secondary logical volumes of the plurality of pairs in the plurality of storage nodes, respectively, based on the number of the pairs and the number of the plurality of storage nodes.

### CROSS REFERENCE TO RELATED APPLICATION

This application relates to and claims the benefit of priority from Japanese Patent Application number 2024-224136, filed on Dec. 19, 2024 the entire disclosure of which is incorporated herein by reference.

### BACKGROUND OF THE INVENTION

### 1. Field of the Invention

The present disclosure relates to a technique for associating data stored in a storage of an active system with data stored in a storage of a standby system.

### 2. Description of Related Art

In the related art, a technique called failover is known in which, when a failure occurs in a storage device operated in an on-premises environment, the operation is taken over to an alternative storage device, thereby enabling data writing and reading to continue.

PTL 1 discloses an example of a system that enables failover when a failure occurs in a server operated in an on-premises environment. When a user specifies a task to be used, the data management device disclosed in PTL 1 forms a pair of a usage volume in the on-premises environment and a copy volume in a cloud environment for the specified task, and manages the configuration of the formed pair.

### Citation List

### Patent Literature

PTL 1: JP2024-129998A

### SUMMARY OF THE INVENTION

When the data management device of PTL 1 creates a pair of a usage volume and a copy volume for the same task unit, a plurality of copy volumes belonging to the same task group may be formed in the same storage node. In this case, for example, at the time of failover, a load of read input (I)/output (O) is added to the storage node to which the plurality of copy volumes are allocated, in addition to write load caused by data copy. Therefore, even if a plurality of storage nodes are provided in the cloud environment, the load is concentrated on a specific node. As a result, when an operation of storage is switched from the active system to the standby system, the overall performance of the storage of the standby system cannot be sufficiently utilized.

One object of the present disclosure is to provide a storage system, a node control method, and a program that can better utilize the performance of the storage of a standby system when the storage being operated is switched from an active system to the standby system.

A storage system according to one aspect of the present disclosure is a secondary storage system connected to a primary storage system including a plurality of primary logical volumes in each of which data is stored, the secondary storage system including: a plurality of storage nodes, each storage node including at least one secondary logical volume; and an arrangement control unit configured to, when there are a plurality of pairs each including one of the primary logical volumes and the secondary logical volume belonging to the same consistency group, distribute and arrange the secondary logical volumes of the plurality of pairs to the plurality of storage nodes, respectively, based on the number of the pairs and the number of the plurality of storage nodes.

According to the one aspect of the present disclosure, the plurality of secondary logical volumes belonging to the same consistency group are distributed and arranged to the plurality of storage nodes. Therefore, even if an operation of data processing is taken over and the data processing increases, the load is distributed to the plurality of storage nodes. As a result, the performance of secondary storage nodes can be more effectively utilized.

### BRIEF DESCRIPTION OF THE DRAWINGS

FIG. 1 is a block diagram illustrating a configuration example of a data processing system including a storage system of Example 1.

FIG. 2 is a block diagram illustrating a configuration example of a secondary storage system.

FIG. 3 is a diagram illustrating an example of a secondary node management table.

FIG. 4 is a diagram illustrating an example of a secondary group management table.

FIG. 5 is a diagram illustrating an example of a secondary volume management table.

FIG. 6 is a diagram illustrating an example of a pair management table.

FIG. 7 is a diagram illustrating an example of a primary storage performance management table.

FIG. 8 is a diagram illustrating an example of a secondary storage performance management table.

FIG. 9 is a diagram illustrating an example of a primary volume performance management table.

FIG. 10 is a diagram illustrating an example of a secondary volume performance management table.

FIG. 11 is a diagram illustrating an example of a hardware structure of a secondary storage system illustrated in FIG. 1.

FIG. 12 is a diagram illustrating an example of a hardware structure of a secondary server illustrated in FIG. 1.

FIG. 13 is a flowchart illustrating an example of an operation procedure of the storage system of Example 1.

FIG. 14 is a flowchart illustrating an example of an operation procedure of the storage system of Example 1.

FIG. 15 is a diagram illustrating an example of an image displayed on a display of an information processing terminal operated by a user.

FIG. 16 is a flowchart illustrating an example of an operation procedure of a storage system of Example 2.

FIG. 17 is a flowchart illustrating an example of an operation procedure of the storage system of Example 2.

FIG. 18 is a flowchart illustrating an example of an operation procedure of a storage system of Example 3.

FIG. 19 is a flowchart illustrating an example of an operation procedure of the storage system of Example 3.

### DESCRIPTION OF EMBODIMENTS

A storage system of the present embodiment is a system including a standby (secondary) storage device that stores a copy of data stored in an active (primary) storage device. In the present embodiment, a system installed in a cloud environment will be described as an example of the storage system, but the installation location of the system is not limited to the cloud environment. Examples of the storage system of the present embodiment will be described below.

### Example 1

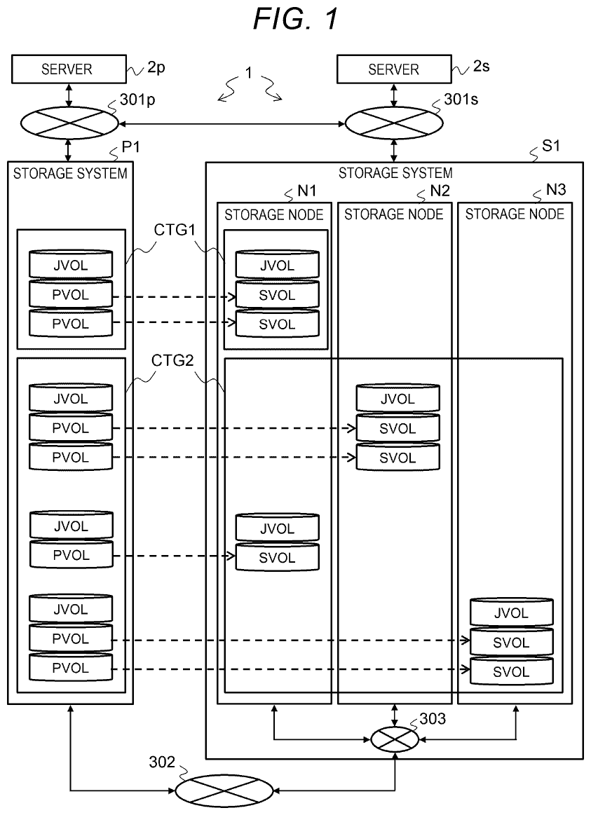

The configuration of a storage system of the present example will be described. FIG. 1 is a block diagram illustrating a configuration example of a data processing system including the storage system of Example 1. As illustrated in FIG. 1, a data processing system 1 includes a primary storage system P1 and a secondary storage system S1.

The storage system P1 is provided in an on-premises environment on a user side who uses the storage system S1. The storage system S1 is provided in a cloud environment. The storage system P1 is connected to a primary server 2p via a network 301p. The storage system S1 is connected to a secondary server 2s via a network 301s. The network 301p and the network 301s are connected via a signal line. The storage system P1 is connected to a network 303 of the storage system S1 via a network 302. One or both of the network 301p and the network 301s are, for example, networks including the Internet.

The data processing system 1 is a system with failover (hereinafter, referred to as F/O) specifications. The F/O refers to automatically switching to a secondary system when a failure occurs in a primary system and continuing processing. Normally, the server 2p and the storage system P1 are in operation, but if a failure or the like occurs in the server 2p or the storage system P1, the operation is switched to the standby server 2s and the storage system S1.

Hereinafter, a logical volume, which is a unit of logical storage area in which data is stored, is referred to as a VOL. A VOL created in a storage device of the primary storage system P1 is called a primary logical volume and referred to as a PVOL. A VOL created in the secondary storage system S1 is called a secondary logical volume and referred to as an SVOL.

The data processing system 1 performs asynchronous remote copy when copying data stored in a PVOL to an SVOL. When remote copy is performed, copy pairs of PVOLs and SVOLs used in the same task such as the same application software program are managed by a consistency group (CTG), which is a group in which consistency of write order is guaranteed. This group is referred to as a consistency group. Hereinafter, the consistency group is simply referred to as a group.

The type of the VOL includes a journal VOL (JVOL) in addition to the PVOL and the SVOL. The JVOL plays the role of a difference VOL that stores difference data between data stored in a PVOL and data stored in a SVOL. For example, when new data is added to the PVOL after the data stored in the PVOL is copied to the SVOL, a difference occurs in the data stored in these VOLs until the next copy is executed. The JVOL stores the difference data until the next copy timing. Accordingly, regardless of when F/O occurs, the same data as before the occurrence of the F/O is provided to a user.

In normal operation, the server 2p executes I/O processing of writing and reading data to and from the storage system P1 in response to a data write request and a data read request from a user. When receiving a write request from the server 2p via the network 301p, the storage system P1 stores data received from the server 2p in the storage device. When receiving a read request from the server 2p via the network 301p, the storage system P1 reads data from the storage device and transmits the data to the server 2p. The storage system P1 transmits a copy of data stored in a plurality of PVOLs to the storage system S1 via the network 302.

When F/O occurs, the server 2s takes over an operation of data processing from the server 2p. Specifically, when F/O occurs, the server 2s executes I/O processing of writing and reading data to and from the storage system S1 in response to a data write request and a data read request form a user.

The storage system S1 is a software defined storage (SDS). The SDS is a distributed storage including a plurality of storage nodes. The SDS automatically creates SVOLs and JVOLs. At this time, the SDS creates SVOLs and/or JVOLs in a storage node with free capacity among the plurality of storage nodes.

As illustrated in FIG. 1, the storage system S1 includes a plurality of storage nodes N1 to N3. Hereinafter, storage nodes are simply referred to as nodes. The nodes N1 to N3 are connected to the network 302 via the network 303. When receiving copy data from the storage system P1 via the network 302, the storage system S1 stores the received copy data in an SVOL of any one of the nodes N1 to N3 via the network 303.

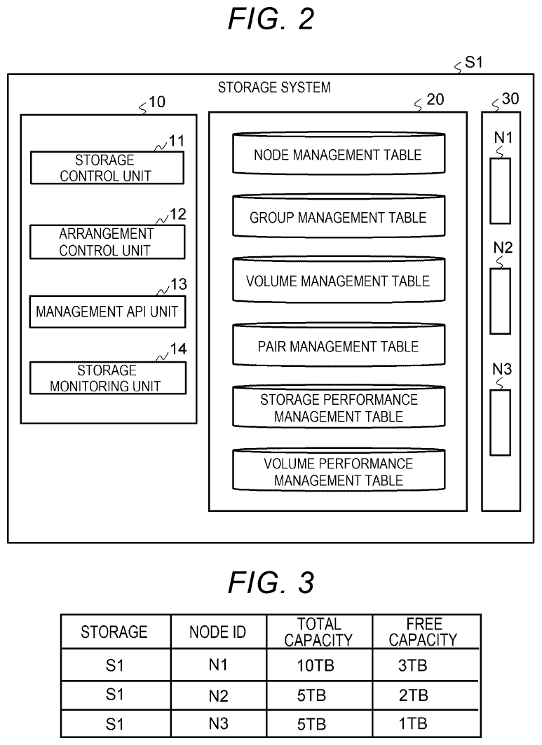

FIG. 2 is a block diagram illustrating a configuration example of a secondary storage system. The storage system S1 includes a control unit 10, a storage unit 20, and a storage device 30. The storage device 30 includes nodes N1 to N3. The control unit 10 and the storage unit 20 correspond to an information processing device such as a computer that controls the nodes N1 to N3 of the storage device 30. The control unit 10 includes a storage control unit 11, an arrangement control unit 12, a management application programming interface (API) unit 13, and a storage monitoring unit 14.

The storage unit 20 stores a node management table, a group management table, a volume management table, a pair management table, a storage performance management table, and a volume performance management table. The storage performance management table includes a primary table and a secondary table. The volume performance management table includes a primary table and a secondary table.

Various tables stored in the storage unit 20 will be described. FIG. 3 is a diagram illustrating an example of a secondary node management table. The node management table is a table for managing a plurality of nodes provided in the storage system S1. In the node management table, a node ID which is an identifier that differs for each node, a total capacity of the node, and a free capacity of the node are registered corresponding to a storage ID. FIG. 3 illustrates a case where there is one secondary storage system, but the number of storage systems may be plural. The node management table illustrated in FIG. 3 is stored in the storage unit 20 in advance.

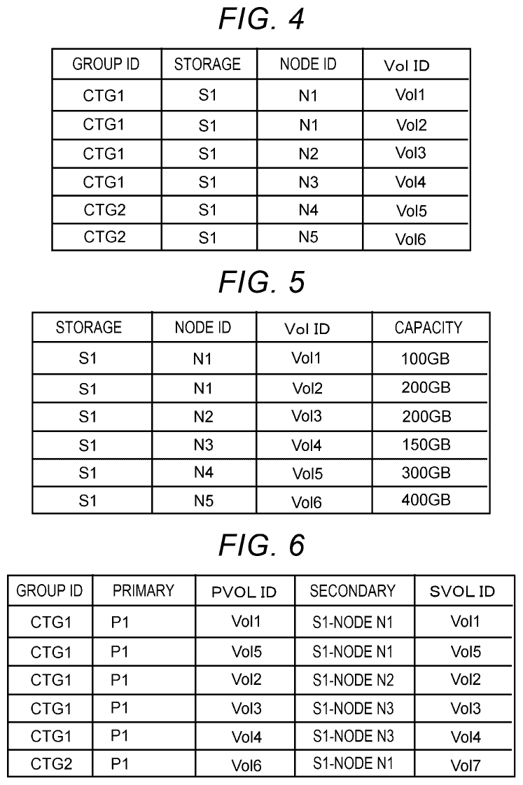

FIG. 4 is a diagram illustrating an example of a secondary group management table. FIG. 4 illustrates a group management table of the storage system S1. In the group management table, a storage ID, a node ID, and a VOL ID are registered corresponding to a group ID. The group ID is an identifier that differs for each group. The VOL ID is an identifier that differs for each SVOL.

FIG. 5 is a diagram illustrating an example of a secondary volume management table. FIG. 5 illustrates a volume management table of the storage system S1. In the volume management table, a VOL ID that differs for each SVOL and a node capacity are registered corresponding to a node ID. The volume management table illustrated in FIG. 5 is stored in the storage unit 20 in advance.

FIG. 6 is a diagram illustrating an example of a pair management table. The pair management table is a table for managing pairs of PVOLs and SVOLs belonging to the same group. In the pair management table, a primary PVOL and a secondary SVOL that form a pair are registered corresponding to a group ID. For a group whose group ID is CTG1, for example, a primary PVOL of Vol1 and a secondary SVOL of Vol1 form a pair. For a group whose group ID is CTG2, a primary PVOL of Vol6 and a secondary SVOL of Vol7 form a pair.

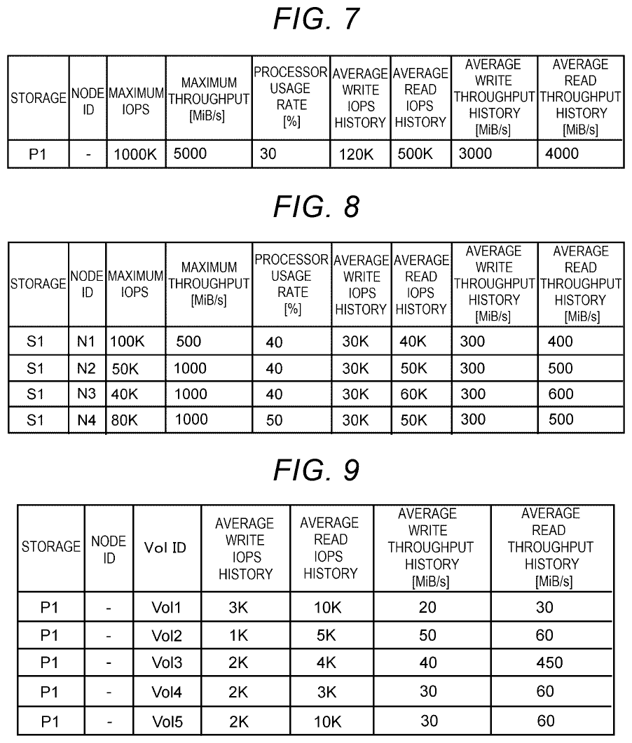

FIG. 7 is a diagram illustrating an example of a primary storage performance management table. The performance and usage history of the storage system P1 are registered in the primary storage performance management table. The performance is the maximum input/output per second (IOPS) and the maximum throughput [MiB/sec]. The usage history includes a processor usage rate [%], an average write IOPS history, an average read IOPS, an average write throughput history [MiB/sec], and an average read throughput history [MiB/sec]. The processor is, for example, a central processing unit (CPU).

FIG. 8 is a diagram illustrating an example of a secondary storage performance management table. The performance and usage history of the storage system S1 are registered in the secondary storage performance management table. The performance is the maximum IOPS and the maximum throughput [MiB/sec]. The usage history includes a processor usage rate [%], an average write IOPS history, an average read IOPS, an average write throughput history [MiB/sec], and an average read throughput history [MiB/sec].

FIG. 9 is a diagram illustrating an example of a primary volume performance management table. In the primary volume performance management table, a usage history of the storage system P1 is registered corresponding to a VOL ID. The usage history includes an average write IOPS history, an average read IOPS, an average write throughput history [MiB/sec], and an average read throughput history [MiB/sec].

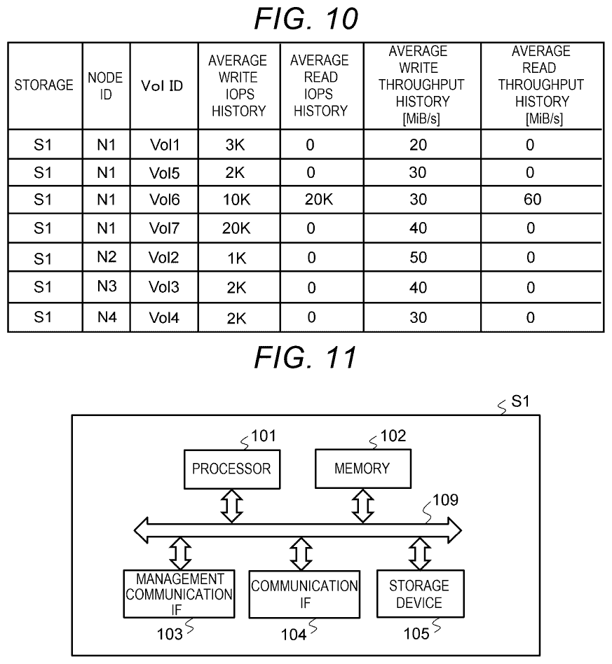

FIG. 10 is a diagram illustrating an example of a secondary volume performance management table. In the secondary volume performance management table, a usage history of the storage system S1 is registered corresponding to a node ID and a VOL ID. The usage history includes an average write IOPS history, an average read IOPS, an average write throughput history [MiB/sec], and an average read throughput history [MiB/sec].

Next, the configuration of the control unit 10 illustrated in FIG. 2 will be described. The storage control unit 11 plays the role of performing basic processing within the storage. Specifically, the storage control unit 11 creates an SVOL or a JVOL using the VOL of each node. The storage control unit 11 creates an SVOL that forms a pair with a PVOL in a node for each group. The storage control unit 11 sets, in two VOLs forming a pair, a logical path indicating a correspondence relation between these two VOLs. In FIG. 1, dashed arrows schematically indicate logical paths. For example, the storage control unit 11 arranges an SVOL corresponding to a PVOL belonging to the same group to any one of the nodes N1 to N3 depending on the free capacity of the nodes. Accordingly, among the nodes N1 to N3, an SVOL is created in a node that has free capacity, and a pair of a PVOL and an SVOL is formed. The storage control unit 11 creates the tables illustrated in FIGS. 4 and 6.

The arrangement control unit 12 determines whether there are a plurality of pairs belonging to the same group for pairs of PVOLs and SVOLs created by the storage control unit 11 for each group. If there are a plurality of pairs belonging to the same group, the arrangement control unit 12 distributes and arranges the SVOLs of the plurality of pairs to the nodes N1 to N3, based on the number of the pairs and the number of nodes N1 to N3 in order to equalize a load on the nodes N1 to N3. The arrangement control unit 12 updates the tables illustrated in FIGS. 4 and 6.

The management API unit 13 plays the role of an interface that receives a request from a user. The request is, for example, a pair creation request instructing creation of a pair of a PVOL and an SVOL. The management API unit 13 instructs the storage control unit 11 and the arrangement control unit 12 to make requests to the VOLs of the nodes N1 to N3.

The storage monitoring unit 14 monitors the nodes N1 to N3. Specifically, the storage monitoring unit 14 monitors how much data is written from the storage system P1 per unit time. After F/O occurs, the storage monitoring unit 14 also monitors how much data is written from the server 2s to the nodes N1 to N3 per unit time. After F/O occurs, the storage monitoring unit 14 monitors how much data is read from the nodes N1 to N3 to the server 2s per unit time. The storage monitoring unit 14 monitors a usage rate of a processor. The storage monitoring unit 14 monitors the performance of the nodes N1 to N3. The performance is, for example, a capacity or a write or read processing speed. The storage monitoring unit 14 records the monitoring results of the processor and the nodes N1 to N3 as a usage history in the tables illustrated in FIGS. 8 and 10.

The storage monitoring unit 14 acquires information on the storage and the processor from the storage system P1 at a predetermined cycle, and creates and updates the tables illustrated in FIGS. 6, 7, and 9. The information on the storage is, for example, information on the VOL ID of each VOL included in the storage, the performance of the storage, and the usage history. The information of the processor is, for example, the usage rate. The storage monitoring unit 14 monitors a logical path corresponding to a group. When an SVOL is moved between nodes by the arrangement control unit 12, the storage monitoring unit 14 continues monitoring of the logical path according to the updated table of FIG. 6.

Here, a hardware structure example of the storage system S1 will be described. FIG. 11 illustrates an example of a hardware structure of a secondary storage system illustrated in FIG. 1. The storage system S1 includes a processor 101, a memory 102, a management communication IF 103, a communication IF 104, and a storage device 105. The nodes N1 to N3 illustrated in FIG. 1 correspond to the storage device 105.

The processor 101 is, for example, a logical operation circuit such as a CPU or a micro processing unit (MPU). The memory 102 is, for example, a non-volatile memory such as a flash memory. The memory 102 stores programs executed by the processor 101. When the processor 101 executes the program stored in the memory 102, the functions of the storage control unit 11, the arrangement control unit 12, the management API unit 13, and the storage monitoring unit 14 illustrated in FIG. 2 are executed.

The management communication IF 103 controls communication between components in the storage system S1. The communication IF 104 controls communication with an external device. The communication IF 104 transmits and receives data to and from an external device according to a communication protocol such as internet protocol (IP). The storage device 105 is, for example, a hard disk drive (HDD) or a solid state drive (SSD). Some or all of the functions of the control unit 10 illustrated in FIG. 2 may be executed by a dedicated circuit such as an application specific integrated circuit (ASIC).

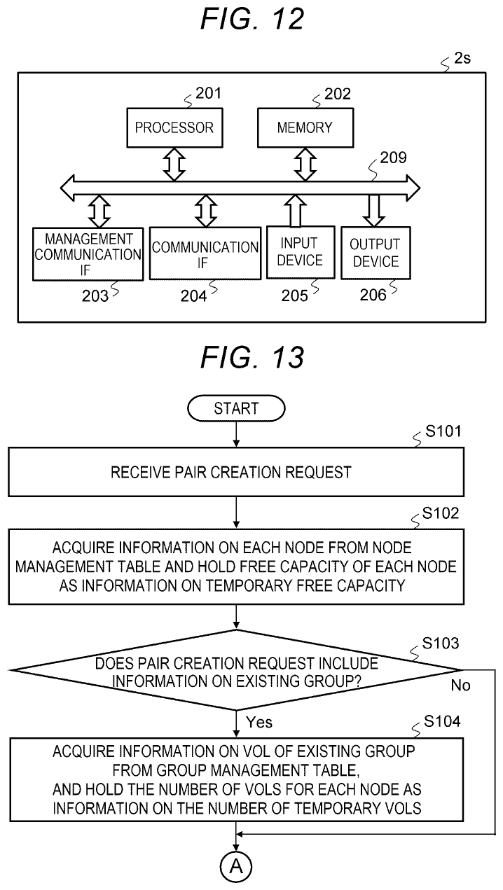

A hardware structure example of the server 2s illustrated in FIG. 1 will be described. FIG. 12 is a diagram illustrating an example of a hardware structure of a secondary server illustrated in FIG. 1. The server 2s includes a processor 201, a memory 202, a management communication IF 203, a communication IF 204, an input device 205, and an output device 206. The processor 201 is, for example, a logical operation circuit such as a CPU or an MPU. The memory 202 is, for example, a non-volatile memory such as a flash memory. The memory 202 may be a hard disk drive (HDD) or a solid state drive (SSD). The memory 202 stores programs executed by the processor 201.

When the processor 201 executes the programs stored in the memory 202, various functions of the server 2s are executed. The management communication IF 203 controls communication between components in the server 2s. The communication IF 204 controls communication with an external device. The communication IF 204 transmits and receives data to and from an external device according to a communication protocol such as IP. The input device 205 is, for example, a keyboard, a mouse, or a touch panel. The output device 206 is, for example, a display or a speaker.

Since the hardware structure of the storage system P1 is the same as the configuration example described with reference to FIG. 11, detailed description thereof will be omitted. Since the hardware structure of the server 2p is the same as the configuration example described with reference to FIG. 12, detailed description thereof will be omitted. In the data processing system 1 illustrated in FIG. 1, an information processing terminal such as a personal computer (PC) for a user to access the storage system S1 may be connected to the network 301p or 301s. Since the hardware structure of the information processing terminal operated by the user is the same as the configuration example described with reference to FIG. 12, detailed description thereof will be omitted. The number of nodes included in the storage system S1 is not limited to three. Although FIG. 1 illustrates a configuration in which the networks 302 and 303 are provided for communication of copy data, the communication of copy data may be performed via the networks 301p and 301s. In this case, the networks 302 and 303 may not be provided.

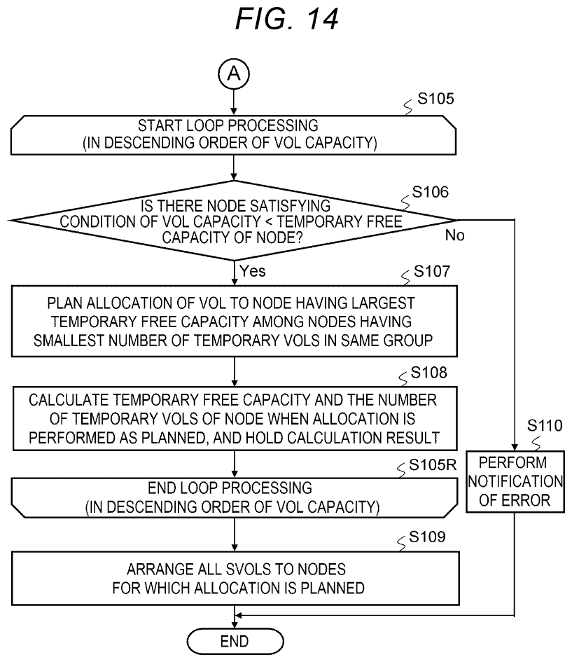

Next, an operation of the storage system S1 of the present example will be described. When the storage system S1 creates a consistency pair, an operation of distributed arrangement will be described. FIGS. 13 and 14 are flowcharts illustrating an example of an operation procedure of the storage system of Example 1.

In step S101, the storage control unit 11 receives a pair creation request. The pair creation request is a request for creating a pair of a PVOL and an SVOL. The pair creation request may be transmitted from an information processing terminal to the storage system S1 by a user inputting a request to the information processing terminal, or may be automatically transmitted by the information processing terminal of the user executing a program. The storage control unit 11 specifies the number of PVOLs for each group, and specifies the number of SVOLs required for pair creation for each group. Accordingly, the number of pairs of PVOLs and SVOLs is determined. The storage control unit 11 holds information in which VOL capacities of SVOLs required for each group are arranged in descending order. In step S102, the arrangement control unit 12 acquires information on each node from the node management table and holds the free capacity of each node as information on a temporary free capacity. The node information is, for example, information such as the number of nodes in each group or the free capacity of nodes in each group.

In step S103, the arrangement control unit 12 determines whether the pair creation request includes information on an existing group. The group information is, for example, a group ID. The group information may be information that specifies a VOL corresponding to the group in each node. Hereinafter, a case where the group information is a group ID will be described. As a result of the determination in step S103, if the pair creation request does not include information on a group ID of an existing group, the arrangement control unit 12 proceeds to the processing in step S105. As a result of the determination in step S103, if the pair creation request includes information on a group ID of an existing group, the arrangement control unit 12 proceeds to the processing in step S104. In step S104, the arrangement control unit 12 acquires information on a VOL of the existing group specified by the group ID from the group management table. Then, the arrangement control unit 12 holds the number of VOLs for each node as information on the number of temporary VOLs.

In steps S105 to S105R, the arrangement control unit 12 executes loop processing in descending order of a VOL capacity for which pair creation is requested by the pair creation request. In step S106, the arrangement control unit 12 determines whether there is a node satisfying a condition “VOL capacity<temporary free capacity of node” among the nodes to which a logical path is set. As a result of the determination in step S106, if there is no node satisfying a condition “VOL capacity<temporary free capacity of node”, the arrangement control unit 12 proceeds to the processing in step S110. In step S110, the arrangement control unit 12 notifies the user of an error. Specifically, the arrangement control unit 12 notifies the user of an error indicating that the capacity is insufficient. Further, the arrangement control unit 12 may propose addition of a node to the user.

On the other hand, as a result of the determination in step S106, if there is a node satisfying a condition “VOL capacity <temporary free capacity of node”, the arrangement control unit 12 proceeds to the processing in step S107. In step S107, the arrangement control unit 12 plans allocation of VOL to a node having the largest temporary free capacity among nodes having the smallest number of temporary VOLs in the same group. A specific example will be described. For a group 2, it is assumed that one temporary SVOL is allocated to the node N1, two temporary SVOLs are allocated to the node N2, and one temporary SVOL is allocated to the node N3. In this case, the nodes N1 and N3 correspond to the nodes having the smallest number of temporary VOLs. If the temporary free capacity of the node N1 is larger than the temporary free capacity of the node N3, the arrangement control unit 12 plans to allocate an SVOL to the node N1. In step S107, the arrangement control unit 12 may extract nodes by using parameters such as whether there is free capacity and the number of VOLs, rather than the amount of free capacity, and select one node from a plurality of nodes if there are a plurality of nodes having the same parameter value.

In step S108, the arrangement control unit 12 calculates the temporary free capacity and the number of temporary VOLs of the node when allocation is performed as planned, and holds the calculation result. In step S105R, the arrangement control unit 12 returns to the processing of step S106 and executes the above processing for the next group. After executing steps S105 to S105R for each group, the arrangement control unit 12 proceeds to step S109. In step S109, the arrangement control unit 12 arranges all SVOLs to the nodes for which allocation is planned. In this way, a plurality of SVOLs forming pairs with a plurality of PVOLs are distributed and arranged to the nodes N1 to N3.

In the related art, from the viewpoint of the same application software program or the like, when a plurality of VOL pairs are formed in group units, a plurality of SVOLs of the same group may be concentrated and arranged to the same node. In this case, when F/O occurs, a load corresponding to the read I/O is concentrated on a node to which the plurality of SVOLs are allocated. Therefore, even if a plurality of nodes are provided in a secondary system, a load is concentrated on a specific node. As a result, when an operation of data processing is switched from a primary system to a secondary system, the overall performance of the storage of the secondary system cannot be sufficiently utilized.

On the other hand, as described with reference to FIGS. 13 and 14, the storage system S1 of the present example distributes and arranges a plurality of SVOLs belonging to the same group to the plurality of nodes N1 to N3. Therefore, it is possible to prevent a load from concentrating on a specific node among the nodes N1 to N3. As a result, the performance of the secondary nodes N1 to N3 can be effectively utilized.

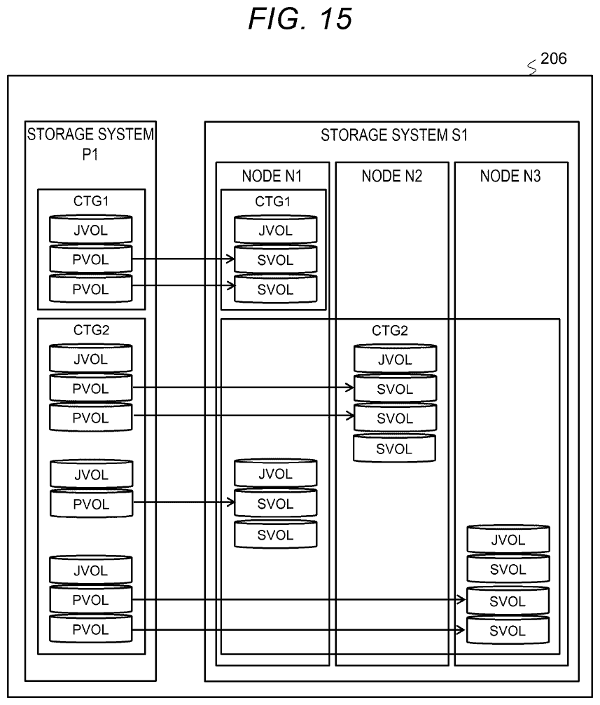

Next, an example in which a user checks a state of distributed arrangement and changes the arrangement method will be described. FIG. 15 is a diagram illustrating an example of an image displayed on a display of an information processing terminal operated by a user. Here, a case will be described where a hardware structure of the information processing terminal operated by the user is the same as the configuration illustrated in FIG. 12, and the output device 206 is a display. The image illustrated in FIG. 15 is a diagram illustrating an example of the distributed arrangement.

In step S101 illustrated in FIG. 13, when a user operates an information processing terminal to input a pair creation request, the storage system S1 executes the flows illustrated in FIGS. 13 and 14, and transmits the processing result to the information processing terminal. The information processing terminal causes the output device 206 to display the image illustrated in FIG. 15. As illustrated in FIG. 15, the image displayed on the output device 206 illustrates a state in which a plurality of pairs of SVOLs are distributed and arranged to the plurality of nodes N1 to N3. The user can determine whether the automatically set distributed arrangement is appropriate by referring to the image illustrated in FIG. 15. If the user determines that the set distributed arrangement is not appropriate, the user may operate the input device 205 of the information processing terminal to change the pair configuration.

The storage system S1 of the present example includes a plurality of nodes N1 to N3, each of which includes at least one SVOL, and the arrangement control unit 12. If there are a plurality of pairs of PVOLs and SVOLs belonging to the same consistency group, the arrangement control unit 12 distributes and arranges the SVOLs of the pairs to the plurality of nodes N1 to N3, respectively, based on the number of the pairs and the number of the plurality of nodes N1 to N3.

According to the present example, a plurality of secondary logical volumes (SVOLs) belonging to the same consistency group are distributed and arranged to the plurality of storage nodes N1 to N3. Therefore, even if the storage system S1 takes over an operation of data processing from a primary system due to the occurrence of F/O and the number of data read requests increases, a load is distributed to the plurality of storage nodes N1 to N3 and the load is equalized on the plurality of storage nodes N1 to N3. As a result, the performance of the secondary storage nodes N1 to N3 can be more effectively utilized.

In a case of an asynchronous remote copy configuration, particularly, a case where an asynchronous remote copy configuration is used for a disaster recovery (DR) application, when an operation is switched from a primary system to a secondary system due to F/O, it is possible to fully utilize the overall performance of secondary storage nodes and prevent a decrease in task performance in secondary system operations. Further, since a user can use the remote copy function capable of distributed VOL arrangement without being aware of the storage nodes provided in the secondary storage system S1, the cloud DR can be easily designed and operated.

Further, according to the present example, when an operation of data processing is switched to the secondary storage system S1 after F/O occurs, data read processing is distributed to the plurality of storage nodes, and thus the data processing can also be performed in a short time. Therefore, the storage system S1 can perform data processing with less energy, and energy efficiency is improved. As a result, it contributes to the improvement of the global environment.

### Example 2

Example 2 is a case where a user specifies required performance for the secondary storage system S1 that is put into operation after F/O occurs. In the present example, the same components as those in Example 1 are denoted by the same reference numerals, and detailed description thereof will be omitted. In the present example, detailed descriptions of the same configurations and operations as those in Example 1 will be omitted, and differences from Example 1 will be described in detail.

A user inputs required performance to the storage system S1 via an information processing terminal. The required performance is, for example, a minimum required performance reference value required by the user when F/O occurs. Since the configuration of the storage system S1 of the present example is the same as the configuration described in Example 1, detailed description thereof will be omitted.

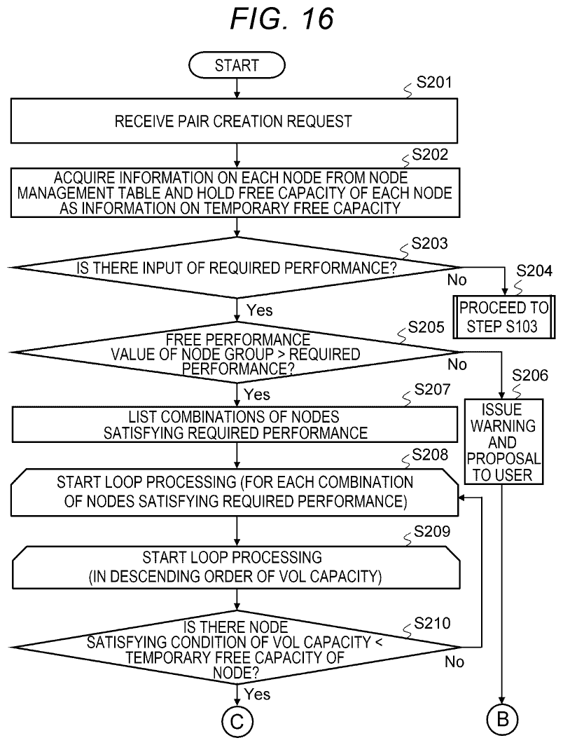

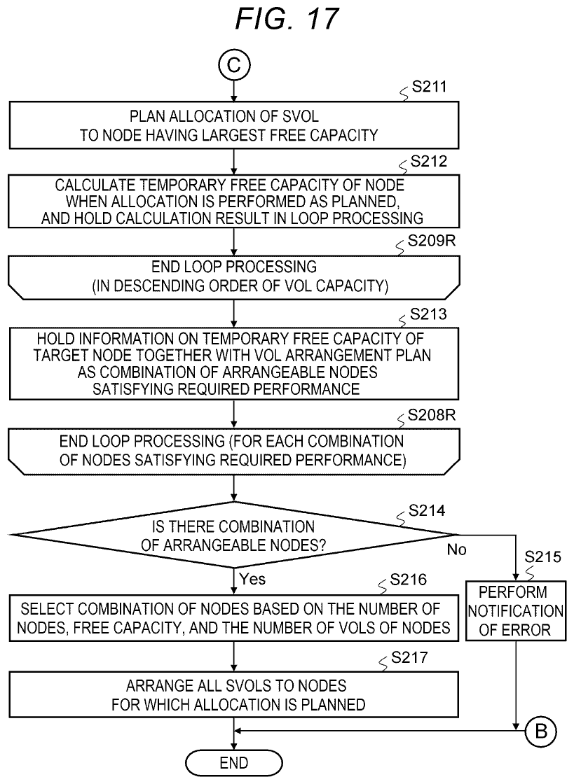

An operation of distributed arrangement processing performed by the storage system S1 of the present example will be described. FIGS. 16 and 17 are flowcharts illustrating an example of an operation procedure of the storage system of Example 2.

In step S201, the storage control unit 11 receives a pair creation request. Since the processing of step S201 is the same as that of step S101 described with reference to FIG. 13, detailed description thereof will be omitted. In step S202, the arrangement control unit 12 acquires information on each node from the node management table. Then, the arrangement control unit 12 holds a free capacity of each node as information on a temporary free capacity. In step S203, the arrangement control unit 12 determines whether there is an input of required performance. The required performance is input from, for example, an information processing terminal operated by a user. Here, a case will be described where the required performance is a performance reference value indicating the minimum required performance specified by the user. As a result of the determination in step S203, if there is no input of required performance, the arrangement control unit 12 proceeds to the processing in step S103 illustrated in FIG. 13.

On the other hand, as a result of the determination in step S203, if there is an input of required performance, the arrangement control unit 12 proceeds to the processing in step S205. In step S205, the arrangement control unit 12 compares a free performance value of a node group with a performance reference value specified by a user. The arrangement control unit 12 determines whether the free performance value of the node group is larger than the performance reference value. Three specific examples of the free performance value of the node group will be described. The first is a maximum performance value of each node group on specifications. The second is a total value of the measured write performance of each node group in this flow processing stage. The third is a total value of the measured write performance of an SVOL operating in each node group and the measured read performance of a PVOL corresponding to the SVOL in this flow processing stage. In the third case, the arrangement control unit 12 may obtain a total value for each group. As a result of the determination in step S205, if the free performance value of the node group is equal to or less than the performance reference value, the arrangement control unit 12 proceeds to the processing in step S206. On the other hand, if the free performance value of the node group is larger than the performance reference value, the arrangement control unit 12 proceeds to the processing of step S207.

In step S206, the arrangement control unit 12 issues a warning and a proposal to the user. Specifically, the arrangement control unit 12 warns the user that the performance is insufficient. The arrangement control unit 12 proposes addition of a node to the user. In step S207, the arrangement control unit 12 lists combinations of nodes satisfying the required performance.

In steps S208 to S208R, the arrangement control unit 12 performs loop processing for each combination of nodes satisfying the required performance. In steps S209 to S209R, the arrangement control unit 12 performs loop processing in descending order of a VOL capacity for which pair creation is requested in a pair creation list. In step S210, the arrangement control unit 12 determines whether there is a node satisfying a condition that the VOL capacity is larger than a temporary free capacity of a node. If there is no node satisfying the condition of step S210, the arrangement control unit 12 returns to the processing of step S208. On the other hand, if there is a node satisfying the condition of step S210, the arrangement control unit 12 proceeds to the processing of step S211.

In step S211, the arrangement control unit 12 plans allocation of SVOL to a node having the largest temporary free capacity. This plan is referred to as a VOL arrangement plan. In step S212, the arrangement control unit 12 calculates a temporary free capacity of a target node when allocation is performed as planned. The arrangement control unit 12 holds information on the temporary free capacity of the target node in the loop processing of steps S208 to S208R. In step S213, the arrangement control unit 12 holds the information on the temporary free capacity of the target node together with the VOL arrangement plan as a combination of arrangeable nodes satisfying the required performance. Specifically, when the allocation of SVOL proceeds by the loop processing, the target node having the largest free capacity changes in step S211. Therefore, by the loop processing, a VOL arrangement plan is established in which SVOLs are allocated in descending order of a free capacity among a plurality of nodes.

In step S214, the arrangement control unit 12 determines whether there is a combination of arrangeable nodes satisfying the required performance. If there is no combination of arrangeable nodes, the arrangement control unit 12 proceeds to the processing of step S215. On the other hand, if there is a combination of arrangeable nodes, the arrangement control unit 12 proceeds to the processing of step S216. In step S215, the arrangement control unit 12 notifies the user of an error. Specifically, the arrangement control unit 12 notifies the user of an error indicating that the capacity is insufficient, and proposes addition of a node.

In step S216, the arrangement control unit 12 selects a combination of nodes based on the number of nodes, the free capacity, and the number of VOLs of the nodes. A specific example of a method for combining nodes will be described. The first combination is a combination in which SVOLs are arranged such that the number of target nodes is reduced. In this case, the processing of obtaining consistency between nodes is simplified. The second combination is a combination in which SVOLs are arranged such that the free capacity is equalized for each node and each VOL arrangement. The third combination is a combination in which SVOLs are arranged such that the number of VOLs is equalized for each node. In step S217, the arrangement control unit 12 arranges all the SVOLs to the nodes for which allocation is planned.

In a case where the user adds a node in step S215, the storage control unit 11 may create a JVOL in the added node when the node is added. In this case, since a JVOL is created when a node is added, it is possible to smoothly start using the added node.

When required performance is input from a user, the storage system S1 of the present example estimates, based on the required performance, the number of nodes required when F/O occurs, and distributes and arranges a plurality of SVOLs to the estimated number of nodes. When it is determined that the number of nodes is insufficient as a result of the estimation, the storage system S1 proposes addition of a node to the user.

According to the present example, when the required performance is input from the user, a plurality of secondary logical volumes are distributed and arranged to a plurality of storage nodes so as to satisfy the required performance. Therefore, even if F/O occurs, the storage system S1 can exhibit the performance required by the user. If the capacity is insufficient even when a plurality of SVOLs are distributed and arranged to the nodes N1 to N3, addition of a node is proposed to the user. Therefore, the user can add a node in advance such that the storage system S1 can exhibit the required performance when F/O occurs.

### Example 3

Example 3 is a case where a performance history of each VOL is monitored and is appropriately rearranged after the start of operation. In the present example, the same components as those in Example 1 are denoted by the same reference numerals, and detailed description thereof will be omitted. In the present example, detailed descriptions of the same configurations and operations as those in Example 1 will be omitted, and differences from Example 1 will be described in detail.

The configuration of the storage system S1 of the present example will be described. The storage monitoring unit 14 monitors a usage history for each of a plurality of PVOLs of the storage system P1. The usage history is, for example, a usage history of performance illustrated in the tables of FIGS. 7 to 10. The arrangement control unit 12 rearranges, based on the usage history of the storage system P1, a plurality of SVOLs belonging to the same group as the plurality of PVOLs to be monitored in the nodes N1 to N3 such that a load on the nodes N1 to N3 is equalized.

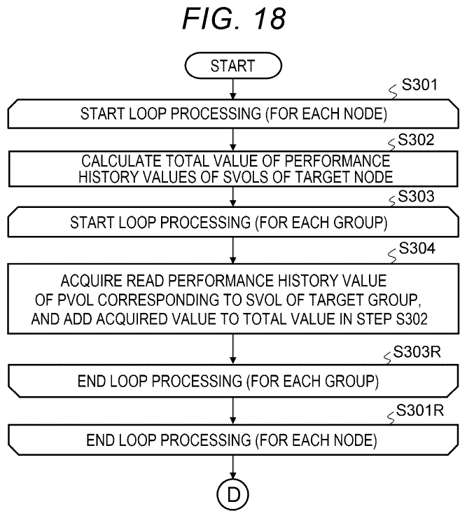

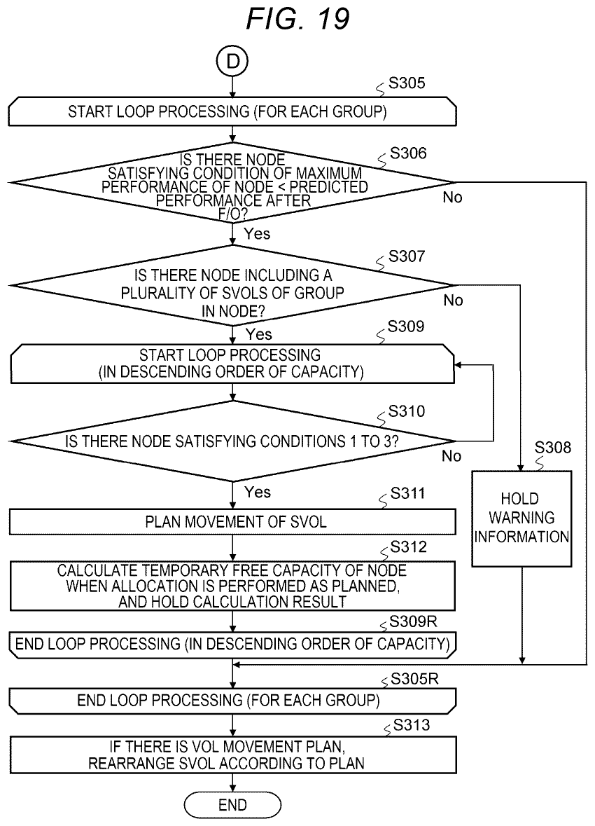

An operation of distributed rearrangement performed by the storage system S1 of the present example will be described. FIGS. 18 and 19 are flowcharts illustrating an example of an operation procedure of the storage system of Example 3. Here, a case where the performance of a VOL is capacity will be described, but the performance is not limited to the capacity. The performance of a VOL may include other parameters such as a processing speed in addition to the capacity.

In steps S301 to S301R, the arrangement control unit 12 performs loop processing for each node. In step S302, the arrangement control unit 12 calculates a total value of performance history values of SVOLs of a target node. The performance history value of an SVOL refers to, for example, the average write IOPS history illustrated in FIG. 10. In steps S303 to S303R, the arrangement control unit 12 performs loop processing for each group. In step S304, the arrangement control unit 12 acquires a read performance history value of a PVOL corresponding to an SVOL of a target group, and adds the read performance history value to the total value calculated in step S302. The read performance history value of a PVOL is, for example, the average read IOPS history illustrated in FIG. 9. The arrangement control unit 12 holds the value calculated in step S304 as predicted performance after F/O of the target node and the target group.

In steps S305 to S305R, the arrangement control unit 12 performs loop processing for each group. In step S306, the arrangement control unit 12 determines whether there is a node satisfying a condition “maximum performance of node<predicted performance after F/O”. The “predicted performance after F/O” refers to “predicted performance after F/O” of each group of each node calculated in step S304. As a result of the determination in step S306, if there is no node satisfying the condition, the arrangement control unit 12 proceeds to the processing of the next group. On the other hand, as a result of the determination in step S306, if there is a node satisfying the condition, the arrangement control unit 12 proceeds to the processing in step S307.

In step S307, the arrangement control unit 12 determines whether there is a node including a plurality of SVOLs of a group in the node. As a result of the determination in step S307, if there is no node including a plurality of SVOLs of a group, the arrangement control unit 12 proceeds to the processing in step S308. In step S308, the arrangement control unit 12 holds warning information indicating that the target group is a target for a warning. Specifically, the arrangement control unit 12 holds, as the warning information, information indicating that the target group is at risk of performance degradation after F/O.

On the other hand, as a result of the determination in step S307, if there is a node including a plurality of SVOLs of a group, the arrangement control unit 12 proceeds to the processing in step S309. In steps S309 to S309R, the arrangement control unit 12 performs loop processing on the target SVOLs in descending order of capacity. Data processing that is highly likely to use a VOL having a large capacity is considered to be temporarily performed. Therefore, it is desirable to migrate a VOL having a large capacity. In step S310, the arrangement control unit 12 determines whether there is a node satisfying conditions 1 to 3. The condition 1 is that the node does not include an SVOL of the target group. The condition 2 is a relation of SVOL capacity<free capacity of node. The condition 3 is a relation of SVOL capacity<temporary free capacity of node after F/O. If there is no node satisfying the three conditions of step S310, the arrangement control unit 12 returns to the processing of step S309 and executes the processing for the SVOL having the next largest capacity.

On the other hand, if there is a node satisfying the three conditions of step S310, the arrangement control unit 12 proceeds to the processing of step S311. In step S311, the arrangement control unit 12 plans the movement of SVOL. The SVOL movement refers to, for example, moving an SVOL that is allocated to the node N1 for a group 1 to the node N2. A case where there are a plurality of options for the destination of an SVOL will be described. In this case, the arrangement control unit 12 may plan the movement of an SVOL according to any rules as long as the node satisfies the condition, such as a node having the largest free capacity or a node having the largest free performance (here, for example, a processing speed). In step S312, the arrangement control unit 12 calculates the temporary free capacity of the node after the planned allocation and holds the calculation result. In step S313, if there is a VOL movement plan, the arrangement control unit 12 rearranges the SVOL according to the plan.

The execution of the flows illustrated in FIGS. 18 and 19 is triggered, for example, when a node is added by a user. The flows illustrated in FIGS. 18 and 19 may be executed not only when a node is added, but also at a fixed cycle, or when an alarm is notified by the storage monitoring unit 14. Steps S301 to S301R illustrated in FIG. 18 may be executed at different timings from steps S305 to S313 illustrated in FIG. 19. In step S313, the arrangement control unit 12 basically moves an SVOL having a larger capacity preferentially, but may move another SVOL preferentially. For example, in terms of performance, it is desirable not to move an SVOL that is likely to be frequently used by a user.

According to the present example, a distributed arrangement state of a plurality of SVOLs to a plurality of nodes N1 to N3 is reviewed based on a usage history of the storage system P1. Therefore, the SVOLs are moved such that a load on the nodes N1 to N3 is equalized in consideration of an I/O load on each node and the specifications of each node. When F/O occurs and the storage system S1 actually starts operation, the load is distributed to the plurality of nodes N1 to N3, and the performance of the nodes N1 to N3 can be more effectively utilized.

The above embodiment is an example for describing the invention, and is not intended to limit the scope of the invention only to the embodiment. Those skilled in the art can implement the invention in various other aspects without departing from the scope of the invention.

The present embodiment includes the following items. However, the items included in the present embodiment are not limited to the following.

### Item 1

A secondary storage system connected to a primary storage system including a plurality of primary logical volumes in each of which data is stored, the secondary storage system including:
a plurality of storage nodes, each storage node including at least one secondary logical volume; and
an arrangement control unit configured to, when there are a plurality of pairs each including one of the primary logical volumes and the secondary logical volume belonging to the same consistency group, distribute and arrange the secondary logical volumes of the plurality of pairs to the plurality of storage nodes, respectively, based on the number of the pairs and the number of the plurality of storage nodes.

Accordingly, the plurality of secondary logical volumes belonging to the same consistency group are distributed and arranged in the plurality of storage nodes. Therefore, for example, even if the storage system takes over an operation of data processing from a primary system due to the occurrence of failover and the number of data read requests from a user increases, a load is distributed to the plurality of storage nodes and the load is equalized on the plurality of storage nodes. As a result, the performance of the secondary storage nodes can be more effectively utilized.

### Item 2

The storage system according to item 1, in which
when required performance is input, the arrangement control unit estimates, based on the required performance, the number of the storage nodes required when failover occurs, and distributes and arranges the plurality of secondary logical volumes to the estimated number of the storage nodes.

Accordingly, when the required performance is input from a user, the plurality of secondary logical volumes are distributed and arranged in the plurality of storage nodes so as to satisfy the required performance. Therefore, even if failover occurs, the secondary storage system can exhibit the performance required by the user.

### Item 3

The storage system according to item 1 or 2, including:
a storage monitoring unit configured to monitor a usage history of the plurality of primary logical volumes, in which
the arrangement control unit rearranges, based on the usage history, the plurality of secondary logical volumes to the plurality of storage nodes.

Accordingly, the distributed arrangement state of the plurality of secondary logical volumes to the plurality of storage nodes is reviewed and rearranged based on the usage history of the primary storage system. Therefore, when failover occurs and the secondary storage system actually starts operation, the load is distributed to the plurality of storage nodes, and the performance of the secondary storage node can be more effectively utilized.

### Item 4

The storage system according to any one of items 1 to 3, in which
the arrangement control unit estimates the number of the storage nodes required when failover occurs, and proposes addition of the storage node to a user when it is determined that the number of the storage nodes is insufficient as a result of the estimation.

Accordingly, if the capacity is insufficient even when the plurality of secondary logical volumes are distributed and arranged in the plurality of nodes, addition of a node is proposed to the user. Therefore, the user can take measures to add a node in advance such that the storage system can exhibit the required performance when failover occurs.

### Item 5

The storage system according to any one of items 1 to 4, including:
a storage control unit configured to create, in each of the storage nodes, the corresponding secondary logical volume and a difference volume that stores difference data between the primary logical volume and the secondary logical volume, in which
when the storage node is added, the storage control unit creates the difference volume in the added storage node.

Accordingly, since the difference volume is created when the storage node is added, it is possible to smoothly start using the added storage node.

### Item 6

The storage system according to any one of items 1 to 5, including:
a storage control unit configured to set, in two logical volumes including the primary logical volume and the secondary logical volume forming each of the pairs, a logical path indicating a correspondence relation between the two logical volumes; and
a storage monitoring unit configured to monitor the logical path corresponding to the consistency group.

Accordingly, even when the secondary logical volumes are moved between the storage nodes by the arrangement control unit, the logical path is maintained corresponding to the consistency group.

### Item 7

The storage system according to any one of items 1 to 6, including:
a display configured to display an image, in which
the arrangement control unit causes the display to display an image indicating a state in which the secondary logical volumes of the plurality of pairs are distributed and arranged to the plurality of storage nodes respectively.

Accordingly, the user can determine whether the setting state of the distributed arrangement is valid by referring to the image indicating the state in which the plurality of secondary logical volumes belonging to the same consistency group are distributed and arranged in the plurality of secondary nodes.

What is claimed is:

1. A secondary storage system connected to a primary storage system including a plurality of primary logical volumes in each of which data is stored, the secondary storage system comprising:
a plurality of storage nodes, each storage node including at least one secondary logical volume; and
an arrangement control unit configured to, when there are a plurality of pairs each including one of the primary logical volumes and the secondary logical volume belonging to the same consistency group, distribute and arrange the secondary logical volumes of the plurality of pairs to the plurality of storage nodes, respectively, based on the number of the pairs and the number of the plurality of storage nodes.

2. The storage system according to claim 1, wherein
when required performance is input, the arrangement control unit estimates, based on the required performance, the number of the storage nodes required when failover occurs, and distributes and arranges the plurality of secondary logical volumes to the estimated number of the storage nodes.

3. The storage system according to claim 1, comprising:
a storage monitoring unit configured to monitor a usage history of the plurality of primary logical volumes, wherein
the arrangement control unit rearranges, based on the usage history, the plurality of secondary logical volumes to the plurality of storage nodes.

4. The storage system according to claim 1, wherein
the arrangement control unit estimates the number of the storage nodes required when failover occurs, and proposes addition of the storage node to a user when it is determined that the number of the storage nodes is insufficient as a result of the estimation.

5. The storage system according to claim 1, comprising:
a storage control unit configured to create, in each of the storage nodes, the corresponding secondary logical volume and a difference volume that stores difference data between the primary logical volume and the secondary logical volume, wherein
when the storage node is added, the storage control unit creates the difference volume in the added storage node.

6. The storage system according to claim 1, comprising:
a storage control unit configured to set, in two logical volumes including the primary logical volume and the secondary logical volume forming each of the pairs, a logical path indicating a correspondence relation between the two logical volumes; and
a storage monitoring unit configured to monitor the logical path corresponding to the consistency group.

7. The storage system according to claim 1, comprising:
a display configured to display an image, wherein
the arrangement control unit causes the display to display an image indicating a state in which the secondary logical volumes of the plurality of pairs are distributed and arranged to the plurality of storage nodes respectively.

8. A node control method to be performed by an information processing device which is connected to a primary storage system including a plurality of primary logical volumes in each of which data is stored, and which controls a plurality of storage nodes each including at least one secondary logical volume, the node control method comprising:
creating a pair including one of the primary logical volumes and one of the secondary logical volumes belonging to the same consistency group; and
when there are the plurality of pairs, distributing and arranging the secondary logical volumes in the plurality of pairs to the plurality of storage nodes, respectively, based on the number of the pairs and the number of the plurality of storage nodes.

9. A program for causing a computer which is connected to a primary storage system including a plurality of primary logical volumes in each of which data is stored, and which controls a plurality of storage nodes each including at least one secondary logical volume to:
create a pair including one of the primary logical volumes and one of the secondary logical volumes belonging to the same consistency group; and
when there are the plurality of pairs, distribute and arrange the secondary logical volumes of the plurality of pairs to the plurality of storage nodes, respectively, based on the number of the pairs and the number of the plurality of storage nodes.
